(19) United States
(12) Patent Application Publication
(10) Pub. No.: US 2025/0113254 A1
(43) Pub. Date: Apr. 3, 2025

(54) DYNAMICALLY MAXIMIZING SUB-CHANNEL BANDWIDTH UTILIZATION FOR OFDMA TRANSMISSIONS WITH ARTIFICIAL INTELLIGENCE (AI)

(71) Applicant: Fortinet, Inc., Sunnyvale, CA (US)

(72) Inventors: Shrikant Gambheer Patil, Sunnyvale, CA (US); Ruchir Mishra, Sunnyvale, CA (US)

(73) Assignee: Fortinet, Inc., Sunnyvale, CA (US)

(21) Appl. No.: 18/375,519

(22) Filed: Sep. 30, 2023

(51) Int. Cl. H04W 28/08; H04W 28/086; H04W 72/52; H04W 84/12

(52) U.S. Cl. CPC H04W 28/0983; H04W 28/0862; H04W 72/52; H04W 84/12

(57) ABSTRACT

Real-time statistics of station RU needs are received. Additionally, real-time statistics of access point RU allocation are received. Real-time statistics for stations and access point history are stored. An artificial intelligence (AI) predictive model is generated for each station based on historical traffic needs. AI model to allocate access point RUs for specific stations in real-time.

### FIELD OF THE INVENTION

The invention relates generally to computer networks, and more specifically, for balancing stations to matching resource unit (RU) usage to RU availability.

### BACKGROUND

WiFi-6 came up with a very important PHY-layer feature: OFDMA (Orthogonal Frequency Division Multiple Access), that allows multiple clients to transmit or receive from an WiFi-6 AP at the same time by sharing available CBW. The purpose was to improve latency in moderate to highly congested RF-environments and improve clients throughput by reducing collision and contention time.

RU allocation to any particular WiFi-6 station is done by the WiFi-6 AP in a trigger-frame containing client's AID, Currently the User Identifier subfield of the Per User Info field of Trigger Frame indicates the AID of the STA to which an RU described in RU Allocation subfield is allocated.

In a scale deployment scenario of a University, Hospital or Airport with large WiFi-6 AP's deployed, utilization of unused RU's can solve major concerns of latencies and congestion.

Hence, its needed for a technique to determine a smart and efficient way of dynamically utilizing these unused RU's at any instance to make the maximum utilization of the RF-medium. Additionally, what is needed is a robust technique for balancing stations to matching RU usage to RU availability.

### SUMMARY

To meet the above-described needs, methods, computer program products, and systems for balancing stations to matching RU usage to RU availability.

In one embodiment, real-time statistics of station RU needs are received. Additionally, real-time statistics of access point RU allocation are received. Real-time statistics for stations and access point history are stored.

In another embodiment, an artificial intelligence (AI) predictive model is generated for each station based on historical traffic needs. AI model to allocate access point RUs for specific stations in real-time.

Advantageously, computer networking is improved with more efficient bandwidth usage.

### DETAILED DESCRIPTION

Methods, computer program products, and systems for balancing stations to matching RU usage to RU availability. One of ordinary skill in the art will recognize many alternative embodiments that are not explicitly listed based on the following disclosure.

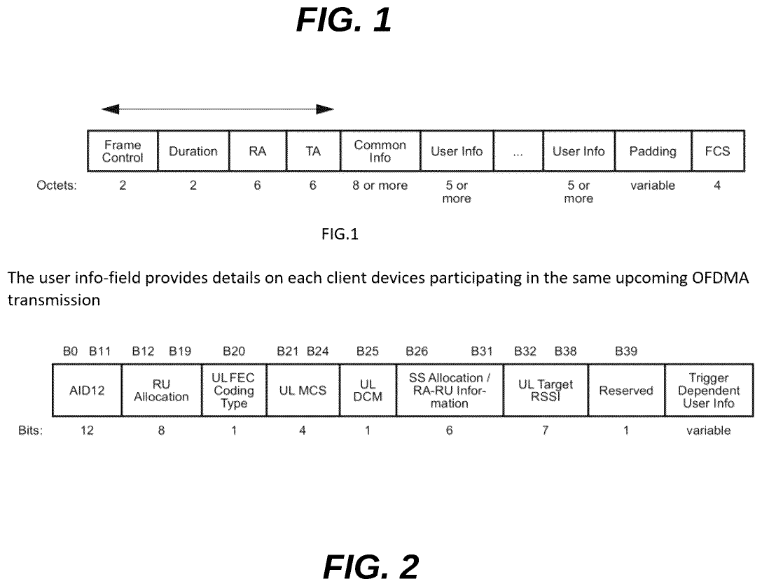

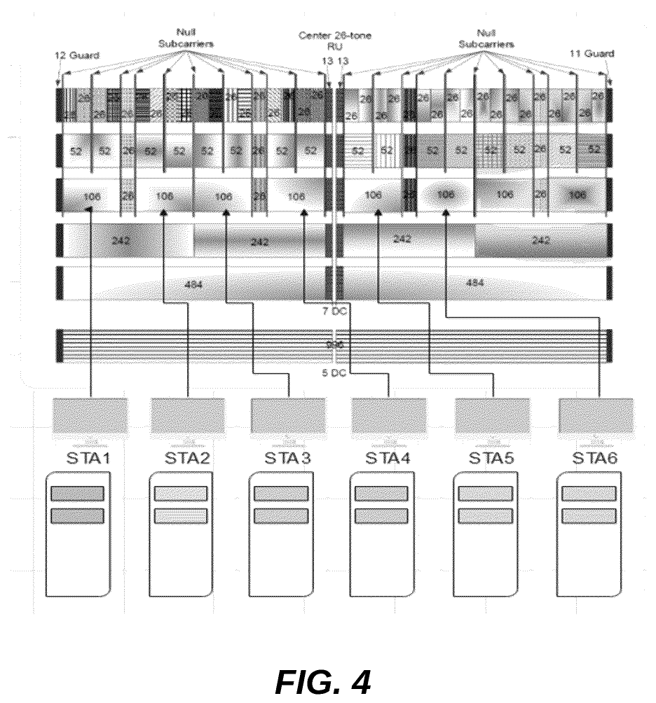

### I. Systems for Balancing RUs (FIGS. 1-3)

We need to make sure that at all times the CBW and RU's are utilized in the most efficient-way for best WiFi-6 client experience, and

### OFDMA in 802.11ax

Different RU-sizes to accommodate different traffic/Tx rates needed
   AP-controls DL & UL transmissions
   STAs channel and buffer info is required
   After transmission STAs respond with MU-Block-ACKs
      OFDMA is great because each station gets to transmit at the same time according to their traffic needs. But as per current OFDMA design we were able to allocate only 1 available RU to each station, this restriction leads to a waste of resources in certain cases.

Each STA can only be assigned a single-RU, leading to:
unused spectral resources
   unexploited frequency diversity gains

OFDMA allows sub-carriers in a single CBW to be grouped in smaller portions called RU's (Resource Units). These individual RU's are assigned to different stations, which allows AP's to serve them simultaneously during uplink or downlink transmissions. Channel bandwidth of 80 MHz will get divided each time a connected client on the AP sends/receives data-traffic; as AP is required to serve client's traffic simultaneously (or in parallel)

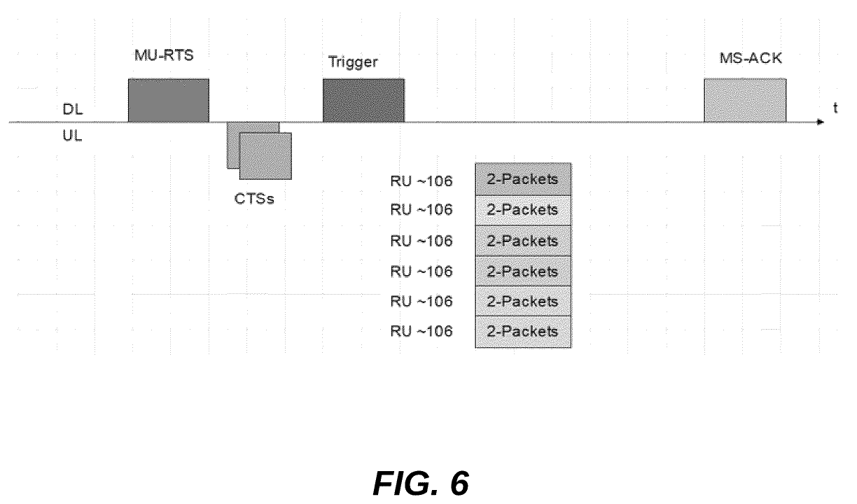

Maximising sub-channel bandwidth utilization for ODEMA transmissions, dynamically via AI & ML; for maximizing overall system-performance; is the goal of current idea proposal. As explained in below FIG. 5, with WiFi-6 stations RU-data gathered from plurality of AP's at Wi-Fi Controller where AI-ML module is running.

Station A, B, C, D, E, F: have low traffic requirements in a given time-sample.

As shown in FIG. 5., all stations have been equally allocated 106 RU-tones each for transmission, by the WiFi-6 AP. As displayed, 2×106 RU-tones are un-utilized on AP1. AI-ML module/algorithm will first detect unused RU-tones (sub-channel-bandwidth) at AP1. Similarly, it will detect/determine such a neighbouring AP (AP2) where RU-tones allocation is already saturated and WiFi-6 clients are not getting ample RU-tones as per their traffic-needs. With this crucial information the AI-ML module will generate a report for the WiFi-Controller to perform a decision-making in-order to roam some clients (STA K & STA L) from AP2 to AP1, where unused RU-tones from AP1 can be allocated to newly roamed stations (STA K & STA L) from AP2 to AP1.
After the above process, On AP2 2× 106 RU-tones are un-utilized; which can be allocated to (STA G) to fulfil it's high-bandwidth traffic needs

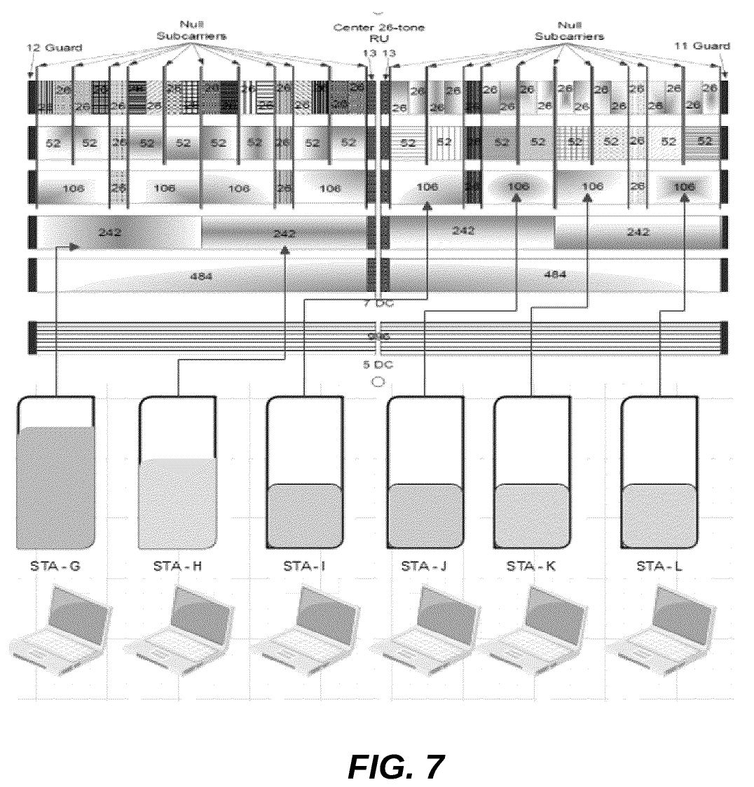

As indicated in FIG. 6, consider a scenario (hypothetical) where
1 RU tone (per station)=2 Packets
It's displayed that each station has equal-packets to be transmitted; as per FIG. 5
2× 106 RU tones are left unutilized

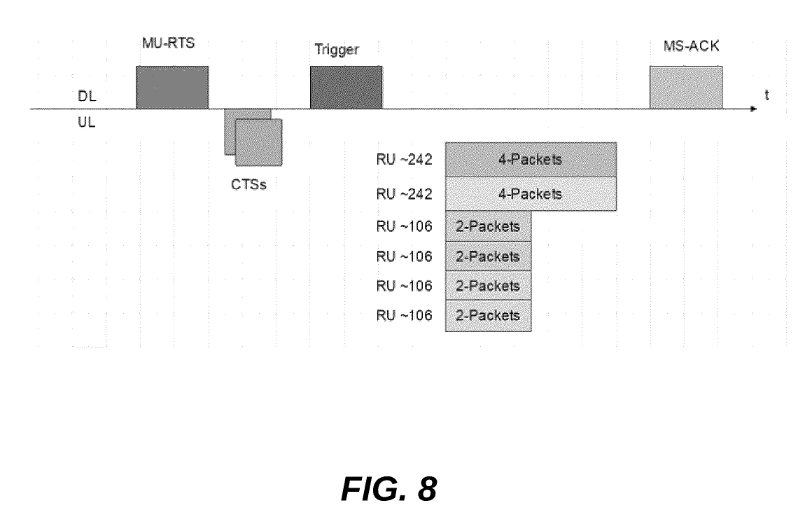

As described in FIG. 7;
Station-G: has very high traffic requirements
Station-H: has moderate traffic requirements
Station I, J, K, L: have low traffic requirements in a given time-sample.

In FIG. 7, Since there are no more RU-tones available to allocate the traffic for/from Station-G will have to await till the next Tx-OP (transmit-opportunity)

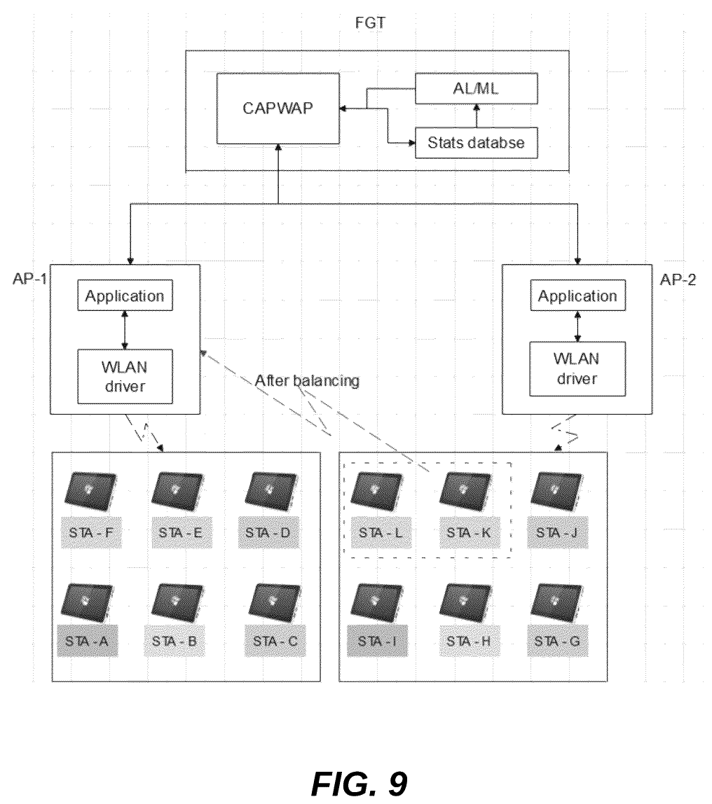

If it's a voice-traffic, delays can cause jitter and latency!
As shown in FIG. 8., Station I, J, K, L have been equally allocated 106 RU-tones each for transmission, by the WiFi-6 AP. Also, closely observe to figure out Station-G and Station-H both got allocated equal 242 RU-tones each for transmission; even though Station-G requires more bandwidth than all others stations; this will create a delay in services at Station-G due to RU-saturation at WiFi-6 AP.

As per the above FIG. 8, even though Station-G has 6 packets for transmission; but because of lower RU-tone allocation (242 RU-tones) it can only sent/receive 4 packets only at a given time-sample.

STA-G remaining traffic, 2 other packets need to be queued for next Tx-OP (transmit-opportunity).

The problem-solution proposes:

To roam/redirect two STAs from AP-2 which are using 106 RU-tones; For e.g. Station K and Station L [re-assignment of these STAs to other APs (AP-1 in this case) will depend on station's RSSI calculation from upstream packets].

Move/fast-roam/fast-bss-transition
Station K and Station L, from AP-2 to AP-1
(Station-G on AP-2 which is using 242 RU-tones, has more Tx/Rx traffic, but it's required BW is not getting satisfied on AP-2 as there no bigger RU is free to allocate)

By this arrangement after re-assigning Station K and Station L from AP-2 to AP-1, freeing-up 2 106 RU-tones which can be allocated to Station-G (on AP-2) so it's traffic requirements gets fulfilled.

Station A, B, C, D, E, F: have low traffic requirements in a given time-sample.

As shown in FIG. 5., all stations have been equally allocated 106 RU-tones each for transmission, by the WiFi-6 AP. As displayed, 2× 106 RU-tones are un-utilized on AP1 (yellow highlighted).
AI-ML module/algorithm will first detect unused RU-tones (sub-channel-bandwidth) at AP1.
Similarly, it will detect/determine such a neighbouring AP (AP2) where RU-tones allocation is already saturated and WiFi-6 clients are not getting ample RU-tones as per their traffic-needs
With this crucial information the AI-ML module will generate a report for the WiFi-Controller to perform a decision-making in-order to roam some clients (STA K & STA L) from AP2 to AP1, where unused RU-tones from AP1 can be allocated to newly roamed stations (STA K & STA L) from AP2 to AP1.
After the above process, On AP2 2× 106 RU-tones are un-utilized; which can be allocated to (STA G) to fulfil it's high-bandwidth traffic needs

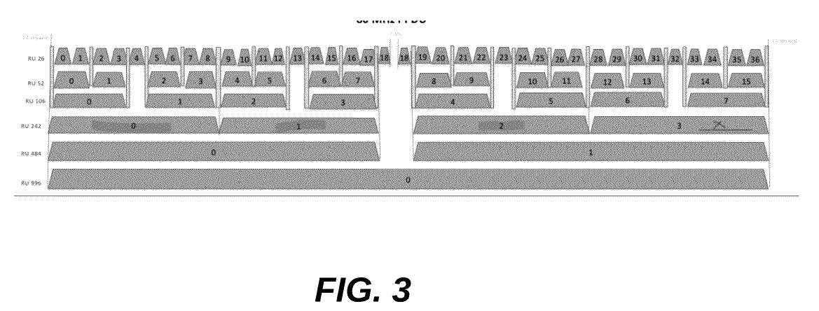

FIG. 2 is a more detailed block diagram illustrating the decoy server 110 of FIG. 1, according to an embodiment. The deception server includes a probing module 210, a profile generation module 220, an OT device profile database 230, and a transmission module 240. Components can be implemented in software and/or software. Many other variations of components are possible.

### II. Methods Balancing RUs

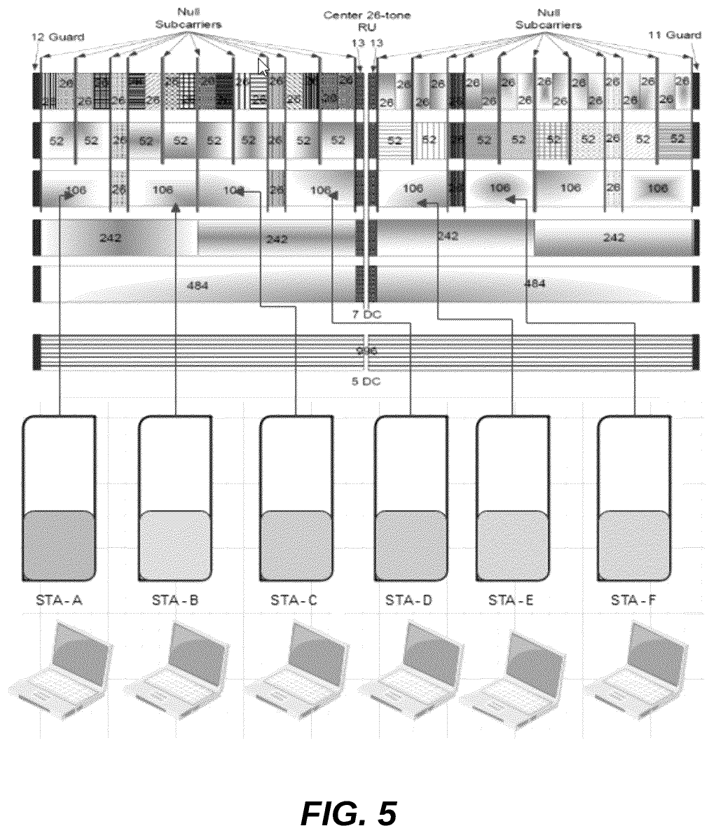

FIG. 4 is a high-level flow diagram illustrating a method 400 for balancing stations to matching RU usage to RU availability, according to an embodiment. The method 400 can be implemented by, for example, system 100 of FIG. 1.

At step 1, real-time statistics of station RU needs are received. At step 2, real-time statistics of access point RU allocation are received. At step 3, real-time statistics for stations and access point history are stored. At step 5, an artificial intelligence (AI) predictive model for each station based on historical traffic needs are generated. At step 6, the AI model to allocate access point RUs for specific stations in real-time are utilized.

### III. Computing Device for Balancing RUs

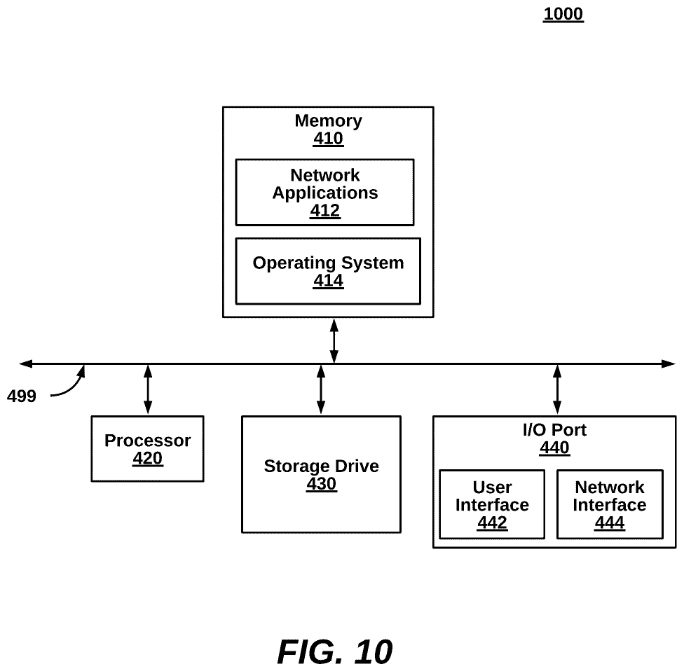

FIG. 10 is a block diagram illustrating a computing device 600 implementing the packet processor 100 of FIG. 1, according to one embodiment. The computing device 600 is a non-limiting example device for implementing each of the components of the system 100, including the Wi-Fi 6E access point 110, access points 120A-C and Wi-Fi 6E station 130. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, OR Windows 7-11), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11 g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A method in a Wi-Fi controller managing a plurality of access points that connect a plurality of stations, for balancing stations to matching resource unit (RU) usage to RU availability, the method comprising the steps:
receiving real-time statistics of station RU needs;
receiving real-time statistics of access point RU allocation;
storing real-time statistics for stations and access point history;
generating an artificial intelligence (AI) predictive model for each station based on historical traffic needs; and
utilizing the AI model to allocate access point RUs for specific stations in real-time.

2. A non-transitory computer-readable medium in a Wi-Fi controller storing computer-readable instructions in a deception server on a data communication network, that when executed by a processor, perform a method for balancing stations to matching resource unit (RU) usage to RU availability, the method comprising:
receiving real-time statistics of station RU needs;
receiving real-time statistics of access point RU allocation;
storing real-time statistics for stations and access point history;
generating an artificial intelligence (AI) predictive model for each station based on historical traffic needs; and
utilizing the AI model to allocate access point RUs for specific stations in real-time.

3. A Wi-Fi controller on a data communication network, for balancing stations to matching resource unit (RU) usage to RU availability, the deception server comprising:
a processor;
a network communication module, communicatively coupled to the processor and to the data communication network; and
a memory, communicatively coupled to the processor and storing:
a first module to receive real-time statistics of station RU needs;
a second module to receive real-time statistics of access point RU allocation;
a third module to store real-time statistics for stations and access point history;
a fourth module to generate an artificial intelligence (AI) predictive model for each station based on historical traffic needs; and
a first module to utilizing the AI model to allocate access point RUs for specific stations in real-time.
